(19) United States
(12) Patent Application Publication
(10) Pub. No.: US 2013/0029024 A1
(43) Pub. Date: Jan. 31, 2013

(54) BARBEQUE STOVE

(71) Applicant: David Warren, Goliad, TX (US)

(72) Inventor: David Warren, Goliad, TX (US)

(21) Appl. No.: 13/190,278

(22) Filed: Jul. 25, 2011

(51) Int. Cl. A47J 37/07; A23L 1/01

(52) U.S. Cl. 426/523; 126/25 R

(57) ABSTRACT

This disclosure describes systems and methods for cooking using a stove system. In some embodiments, a method of heating materials using a stove may include inserting fuel through a third conduit positioned substantially above a fourth conduit. In some embodiments, the method may include allowing air to flow through the fourth conduit and a second opening. In some embodiments, the method may include inhibiting flames from reaching the second end of the first conduit using a deflector. In some embodiments, the method may include heating a heating surface coupled to the second end of the first conduit. In some embodiments, the method may include elevating the heating surface above the second end of the first conduit using a spacer. In some embodiments, the method may include inhibiting escape of heated fluids from the first conduit such that a heating surface is heated by the heated fluids.

### BACKGROUND OF THE INVENTION

1. Field of the Invention

The present disclosure generally relates to stoves. More particularly, the disclosure generally relates to stove systems for cooking outdoors.

2. Description of the Relevant Art

Grilling is an extremely popular method of cooking and enhances the flavor of food while reducing fat compared to other cooking techniques. To enjoy the many health benefits of grilled food, backyard barbeque grills have become very popular and can be found in many households. These back-yard barbeque grills use charcoal or charcoal briquettes as fuel.

Grilling foods is also extremely popular among outdoor enthusiasts (e.g., hunters, campers, hikers) who often grill their food, because grilling is well suited for outdoor use and can make use of fuels that are readily available in nature.

As a consequence of the foregoing situation, there has existed a longstanding need for a new and improved type of wood burning barbeque grill construction.

United States Patent Application Publication No. 2010/0258104 issued to Defoort et al. (hereinafter “Defoort”) discloses a cook stove assembly including an annular constriction connected to a combustion chamber. The annular constriction aids in directing partially combusted gases away from the periphery of the combustion chamber and towards the flame front. However, Defoort does not disclose, for example, a deflector to inhibit flames from exiting the annular constriction.

U.S. Pat. No. 5,865,099 issued to Waugh (hereinafter “Waugh”) discloses a barbeque grill assembly including a bowl and a domed, free-standing lid mating with each other including a smoker assembly for holding fuel and having damper means. However, Waugh does not disclose a spacer coupled to a heating surface to allow heated fluids escape between the heating surface and a supporting conduit. Although there exist many different types of stoves none of the known devices accomplish what the herein described stove is capable of.

As a consequence of the foregoing situation, there has existed a longstanding need for a new and improved type of wood burning barbeque grill construction.

### SUMMARY

This disclosure describes systems and methods for heating materials on a stove system. In some embodiments, a stove system may include a first conduit. The first conduit may include a first diameter, a first end, a second end, and a second opening. The first end may inhibit, during use, fuel positioned in the first conduit from exiting the first conduit. The second end of the first conduit may include a first opening. The second opening may be positioned in a first side of the first conduit substantially adjacent the first end of the first conduit.

In some embodiments, the stove system may include a second conduit. The second conduit may be coupled to a second side of the first conduit substantially adjacent the first end of the first conduit. The second side of the first conduit may be substantially opposite the first side of the first conduit. The second conduit may be substantially orthogonal to the first conduit.

In some embodiments, the second conduit may include a second diameter, a divider, a third end, and a fourth end. The second diameter may be smaller than the first diameter of the first conduit. The divider may be positioned at least within the second conduit. The divider may divide the second conduit into a third and a fourth conduit. The third conduit may be positioned substantially above the fourth conduit. The third conduit may allow at least fuel to be positioned in the first conduit. The fourth conduit may allow air to enter the first conduit. The third end of the second conduit may include a third opening which couples the interior of the first conduit to the interior of the second conduit. The fourth end of the second conduit may include a fourth opening which allows communication with the third opening through the second conduit.

In some embodiments, the stove system may include at least one elongated member coupled to an exterior surface of the first end of the first conduit. The at least one elongated member may raise, during use, the first conduit above a surface upon which the stove is positioned

In some embodiments, the fuel may include wood, wood pellets, etc.

In some embodiments, the divider may extend beyond the fourth opening of the second conduit.

In some embodiments, a distance between an upper exterior surface of the second conduit and the second end of the first conduit may be about 4 inches to about 6 inches or about 4.5 inches to about 5.5 inches.

In some embodiments, the first conduit may include a substantially square cross section with an approximately 5 inch width. The second conduit may include a substantially square cross section with an approximately 4 inch width.

In some embodiments, the stove system may include a lip coupled to the exterior surface of the first conduit below the second opening. The lip may be angled towards the second end of the first conduit such that solid materials are inhibited from exiting the first conduit through the second opening.

In some embodiments, the second opening and the fourth conduit may allow air to flow through the first conduit.

In some embodiments, the stove system may include a deflector coupled to an interior surface of the first side of the first conduit substantially adjacent the second end of the first conduit. The deflector assists in inhibiting flames from reaching the second end of the first conduit.

In some embodiments, the stove system may include a heating surface coupled to the second end of the first conduit. The heating surface may include a plurality of openings such that heat produced in the first conduit is transferred to a material positioned on and/or above the heating surface.

In some embodiments, the stove system may include a spacer coupled to the heating surface. The spacer may elevate the heating surface about 0.5 inches above the second end of the first conduit allowing heated fluids to exit between the heated surface and the second end of the first conduit.

In some embodiments, the heating surface may include a lip coupled to at least a portion of a perimeter of the heating surface. The lip inhibits escape of heated fluids from the first conduit such that the lip is heated by the heated fluids

In some embodiments, a method of heating materials using a stove may include inserting fuel through a third conduit positioned substantially above a fourth conduit. The third and fourth conduit may form a second conduit. The second conduit may be coupled to a second side of a first conduit substantially adjacent a first end of the first conduit. The second side of the first conduit may be substantially opposite a first side of the first conduit. The second conduit may be substantially orthogonal to the first conduit.

In some embodiments, the method may include positioning fuel in the first end of the first conduit.

In some embodiments, the method may include allowing air to flow through the fourth conduit and a second opening positioned in the first side of the first conduit substantially adjacent the first end of the first conduit.

In some embodiments, the method may include inhibiting flames from reaching the second end of the first conduit using a deflector coupled to an interior surface of the first side of the first conduit substantially adjacent the second end of the first conduit.

In some embodiments, the method may include heating a heating surface coupled to the second end of the first conduit. The heating surface may include a plurality of openings such that heat produced in the first conduit is transferred to a material positioned on and/or above the heating surface.

In some embodiments, the method may include elevating the heating surface above the second end of the first conduit using a spacer coupled to the heating surface such that the heating surface is elevated above the second end of the first conduit.

In some embodiments, the method may include allowing heated fluids to exit between the heated surface and the second end of the first conduit.

In some embodiments, the method may include inhibiting escape of heated fluids from the first conduit such that a lip is heated by the heated fluids. The lip may be coupled to at least a portion of a perimeter of the heating surface.

### BRIEF DESCRIPTION OF THE DRAWINGS

Advantages of the present invention may become apparent to those skilled in the art with the benefit of the following detailed description of the preferred embodiments and upon reference to the accompanying drawings.

FIG. 1 depicts a front perspective view of a diagram of an embodiment of a stove.

FIG. 2 depicts a rear perspective view of a diagram of an embodiment of a stove.

FIGS. 3A-B depict a view of a diagram of an embodiment of an extension member of a stove system and a side view of the stove system with the extension member positioned.

FIG. 4 depicts a cross sectional side view of a diagram of an embodiment of a stove.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

It is to be understood the present invention is not limited to particular devices or biological systems, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Thus, for example, reference to “a linker” includes one or more linkers.

### DEFINITIONS

Unless defined otherwise, all technical and scientific terms used herein have the same meaning as commonly understood by one of ordinary skill in the art.

The term “conduit” as used herein generally refers to a hollow shaft or tube whose cross section is not limited to any particular shape.

The term “connected” as used herein generally refers to pieces which may be joined or linked together.

The term “coupled” as used herein generally refers to pieces which may be used operatively with each other, or joined or linked together, with or without one or more intervening members.

The term “directly” as used herein generally refers to one structure in physical contact with another structure, or, when used in reference to a procedure, means that one process effects another process or structure without the involvement of an intermediate step or component.

The term “heated fluids” as used herein generally refers to heated gases produced by burning fuel in the stove. Heated fluids may include ambient air within the stove heated by the fire therein. Heated fluids may include the flames from the fire.

In some embodiments, a system may include a stove device. The stove may be used to heat and/or cook items. The stove may be used to heat materials outdoors. As with any stove, efficiency of the device is important but when using an outdoor stove efficiency is even more important. Indoor stoves (e.g., electric, gas) are typically connected to city utilities which provide a virtually unlimited supply of power to a home owners typical indoor stove. However, outdoor stoves usually have a limited supply of fuel available and/or is simply more difficult to obtain than merely paying your utility bill on time. Therefore improving the efficiency of an outdoor stove such that the fuel used by the stove is used as efficiently as possible is of paramount importance.

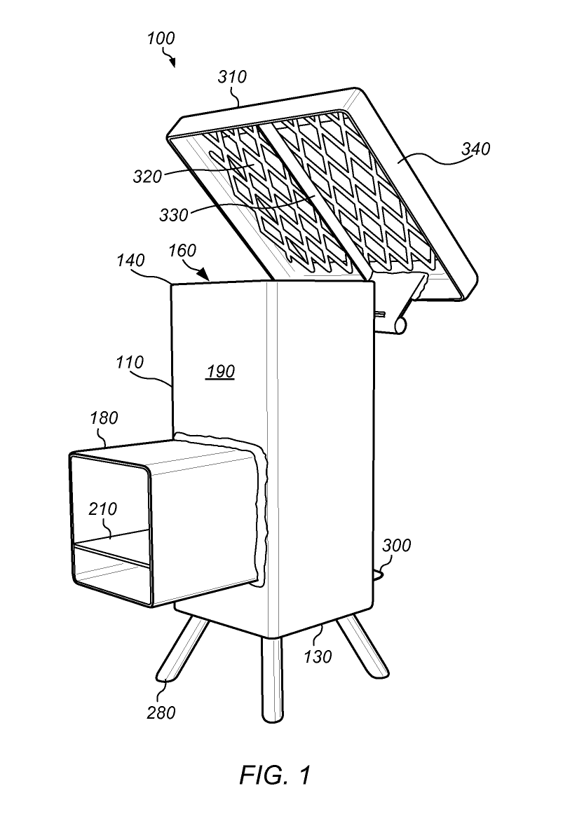

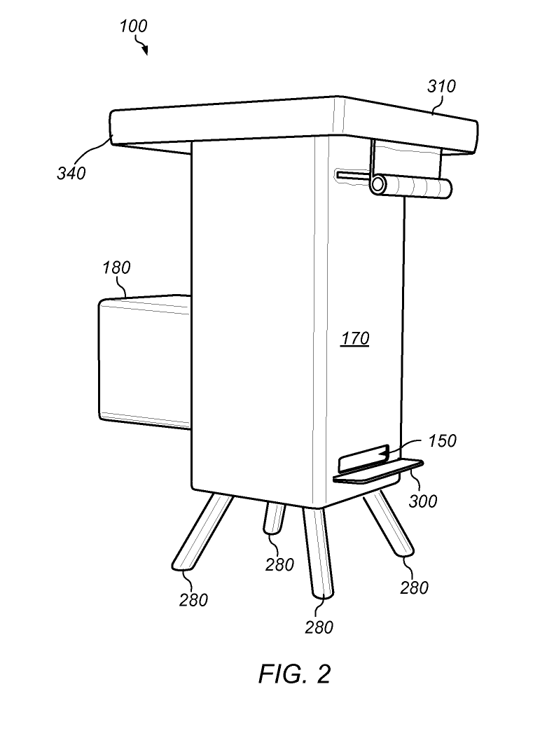

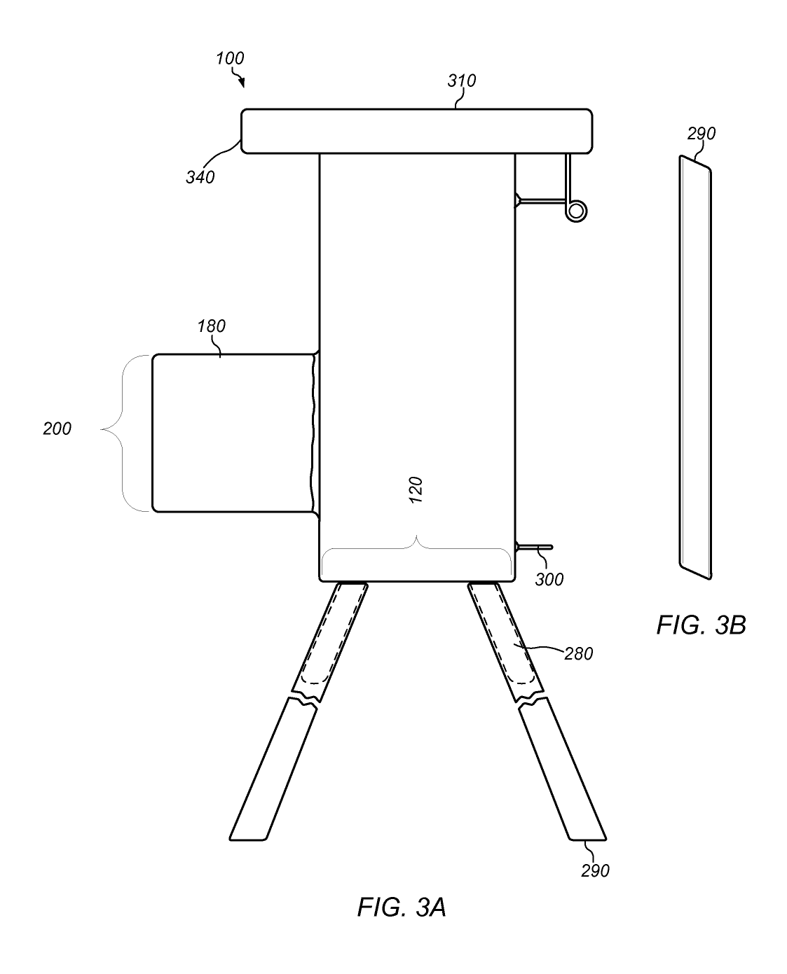

FIG. 1 depicts a front perspective view of a diagram of an embodiment of stove 100. FIG. 2 depicts a rear perspective view of a diagram of an embodiment of stove 100. In some embodiments, stove system 100 may include first conduit 110. First conduit 110 may include first diameter 120 (see FIG. 3A), first end 130, second end 140, and second opening 150. First end 130 may inhibit, during use, fuel positioned in first conduit 110 from exiting the first conduit. Second end 140 of first conduit 110 may include first opening 160.

Second opening 150 may be positioned in first side 170 of first conduit 110 substantially adjacent first end 130 of first conduit 110. In some embodiments, second opening 150 may be about 0.25 to 1 inch in height (e.g., about 0.5 inches). In some embodiments, second opening 150 may be about 2.5 to 3.5 inches in width (e.g., about 3 inches). In some embodiments, the width and height may also vary depending upon the relative dimensions of the first and second conduit. Positioning the second opening and/or the second conduit above the first end of the first conduit may allow for the collection of more ash at the first end of the first conduit such that a fire may burn longer.

In some embodiments, stove system 100 may include second conduit 180. Second conduit 180 may be coupled to second side 190 of first conduit 110 substantially adjacent first end 130 of the first conduit. The second side of the first conduit may be substantially opposite the first side of the first conduit. The second conduit may be substantially orthogonal to the first conduit.

It should be noted that the term conduit should not be viewed as limiting the shape of a cross section of a conduit as described herein. A cross section of one or more conduits forming a stove system may have any number of shapes. Different portions of the conduits used to form the stove may have different cross sectional shapes. In some embodiments, a conduit's cross sectional shape may include a square, a rectangle, a circular, an oval, or an irregular shape. In some embodiments, the first conduit and the second conduit may have a substantially square cross sectional shape.

In some embodiments, as stated, first end 130 may inhibit, during use, fuel positioned in first conduit 110 from exiting the first conduit. In some embodiments, the first end may be sealed or closed off. In some embodiments, the first end of the first conduit may include a mechanism which allows the first end to be opened by a user during use. The ability to open the first end of the first conduit may allow for materials within the first conduit to more easily be removed by a user. For example after a stove has been used to heat something, the first end of the first conduit may be opened to remove any ashes or any other waste materials remaining. In some embodiments, the first end of the first conduit may include a mechanism (e.g., a damper or plate) allowing access to the interior of the first conduit. The mechanism may be, for example, on a hinge.

In some embodiments, second conduit 180 may include second diameter 200, divider 210, third end 220, and fourth end 230. Third end 220 of second conduit 180 may include third opening 240 which couples the interior of first conduit 110 to the interior of the second conduit. Fourth end 230 of second conduit 180 may include fourth opening 250 which allows communication with third opening 240 through the second conduit. Second diameter 200 may be smaller than first diameter 120 of first conduit 110. In some embodiments, first conduit 110 may include a substantially square cross section wherein first diameter 120 is approximately 4 to 6 inches (e.g., 5 inches). In some embodiments, second conduit 180 may include a substantially square cross section wherein second diameter 200 is approximately 3 to 5 inches (e.g., 4 inches).

In some embodiments, a bottom of second conduit 180 may be positioned about 1.5 to 2.0 inches from first end 130 of first conduit 110. In some embodiments, a bottom of second conduit 180 may be positioned about 1.75 inches from first end 130 of first conduit 110.

Divider 210 may be positioned at least within second conduit 180. Divider 210 may divide the second conduit into third conduit 260 and fourth conduit 270. The third conduit may be positioned substantially above the fourth conduit. The third conduit may allow at least fuel to be positioned in the first conduit. Fuels used for a stove system described herein may typically include fuels associated with stoves of this nature. Fuels may include solid fuels. Fuels may include different types and forms of wood (e.g., naturally gathered wood, wood pellets, etc.). In some embodiments, third conduit 260 may extend the full width of second conduit 180 (e.g., about 4 inches) and be about three-quarters of the height of second conduit 180 (e.g., about 2.75 inches). In some embodiments, fourth conduit 270 may extend the full width of second conduit 180 (e.g., about 4 inches) and be about one-quarter of the height (e.g., about 1.25 inches) of second conduit 180. In some embodiments, the width and height of the third and fourth conduits may also vary depending upon the relative dimensions of the first and second conduit. Advantages of the second conduit having a smaller diameter than the first conduit may include allowing for fuel, inserted through the third conduit and at least partially positioned in the first conduit, to have space between the fuel protruding into the first conduit and the interior surface of the walls of the first conduit. This space between the fuel and the interior surface of the first conduit allows better air flow around the fuel such that the fuel burns more efficiently.

In some embodiments, divider 210 may extend beyond the fourth opening of the second conduit. Extending the divider may allow additional fuel to be positioned on the divider. For example, longer sticks of wood may be more safely positioned in the third conduit atop the divider if the divider extends further outside beyond the fourth opening.

In some embodiments, fourth conduit 270 may allow air to enter first conduit 110. In some embodiments, second opening 150 and fourth conduit 270 may be positioned on substantially opposite sides of first conduit 110. In some embodiments, second opening 150 and fourth conduit 270 may allow air to flow through first conduit 110. It is crucial to allow an appropriate flow of air through the first conduit such that any fire in the first end of the first conduit is provided with enough oxygen. The cross draft provided by second opening 150 and fourth conduit 270 should not be too large or one risks extinguishing the fire or causing the fire to burn out of control. The cross draft provided by second opening 150 and fourth conduit 270 should not be to small or one risks not providing enough oxygen resulting in the fire extinguishing and/or trouble initially lighting the fuel to create the fire.

In some embodiments, the level of the third opening of the second conduit as it relates to the level of the first end of the first conduit may be a significant component of the airflow and combustion efficiency of the stove system. The dimensions and relative elevations of fourth conduit 270 and second opening 150 combined with their distance to first end 130 are important to efficiently burn the fuel in the combustion chamber (e.g., allowing an appropriate amount of air to enter the space where fuel is burned). This distance also creates space where ashes can collect therefore prolonging burn time.

In some embodiments the flow of air through the second opening and the fourth conduit may be controlled by appropriately sizing both openings. In some embodiments, the sizing of one or both openings may be controlled during production. In some embodiments, the sizing of one or both openings may be controlled using a mechanism such as a hinged or sliding door or obstruction. The obstruction may be positioned to block a portion or all of one or both of the openings to assist in controlling the flow of air through the openings.

In some embodiments, stove system 100 may include at least one elongated member 280 coupled to an exterior surface of first end 130 of first conduit 110. The at least one elongated member may raise, during use, the first conduit above a surface upon which the stove is positioned. In some embodiments, stove system 100 may include 4 elongated members 280 coupled to an exterior surface of first end 130 of first conduit 110. The elongated members may be of any length depending upon the desired height of the stove system. In some embodiments, the elongated members may be relatively short for safety reasons such that the stove system has a lower center of gravity therefore adding stability. The elongated members may be about 1 to 6 inches, about 2 to 4 inches, or about 2.5 inches. In some embodiments, the elongated members may be coupled to the first conduit such that they are at an angle relative to the conduit and not parallel to the body of the first conduit. Coupling the elongated members to the first end of the first conduit at an angle relative to the first conduit may provide further stability to the stove system.

In some embodiments, stove system 100 may include at least one extension member 290. Extension members 290 may function to extend the length of elongated members 280. Extension members 290 may function to adjust the height of stove system 100. In some embodiments, stove system 100 may come with at least one extension member 290 for every elongated member 280. In some embodiments, extension member 290 may be coupled to elongated member 280. A variety of techniques may be used to couple an extension member to an elongated member.

FIGS. 3A-B depict a view of a diagram of an embodiment of extension member 290 of stove system 100 and a side view of stove system 100 with extension member 290. In some embodiments, extension member 290 may include a shaft or conduit. Extension member 290 may be longer than elongated member 280. The lumen of the conduit forming extension member 290 may be sized such that elongated member 280 is positionable within the extension member. Elongated members 280 may be positioned, during use, in extension member 290 therefore effectively extending the length of the elongated member (in such an embodiment the extension member may not actually be coupled to the elongated member, merely positioned inside).

In some embodiments, stove system 100 may include lip 300 coupled to the exterior surface of first conduit 110 below second opening 150. In some embodiments, lip 300 may be angled towards second end 140 of first conduit 110 such that solid materials are inhibited from exiting the first conduit through second opening 150. In some embodiments, lip 300 may be at least as wide or wider as second opening 150 (e.g., about 4 inches). In some embodiments, lip 300 may be about 0.5 to about 2 inches in depth (e.g., about 1 inch).

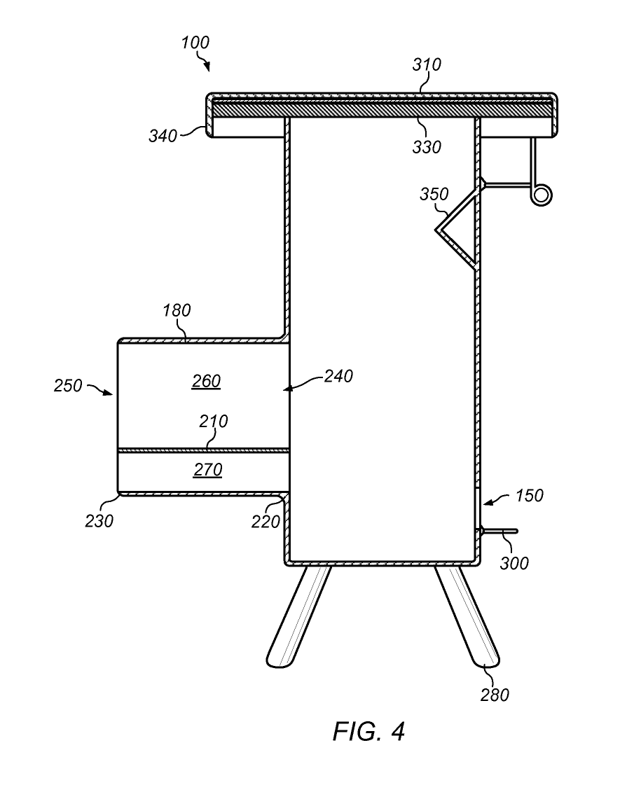

FIG. 4 depicts a cross sectional side view of a diagram of an embodiment of a stove. In some embodiments, stove system 100 may include heating surface 310 coupled to second end 140 of first conduit 110. In some embodiments, heating surface 310 may be coupled to second end 140 of first conduit 110 with a hinge type mechanism. Coupling the heating surface ensures that the heating surface is never separated from the stove (which may result in the heating surface being lost). Using a hinge to couple the heating surface to the stove may allow a user to more easily access the interior of the first conduit to, for example, clean the first conduit after use. Heating surface 310 may include a plurality of openings 320 such that heat produced in first conduit 110 is transferred more easily to a material positioned on and/or above the heating surface.

In some embodiments, a distance between an upper exterior surface of the second conduit and second end 140 of first conduit 110 may be about 4 inches to about 6 inches or about 4.5 inches to about 5.5 inches. In some embodiments, the distance may be about 5 inches. This distance may be significant to ensure that the proper amount of heat reaches a heating surface. The distance of 4.5-5.5 inches proves to be the ideal distance to ensure that the proper amount of heat reaches the heating surface. For example, less than 4 inches causes difficulty in regulating cooking temperature and results in overheating. For example, if over 6 inches then not enough heat makes it to the surface to cook properly.

In some embodiments, stove system 100 may include spacer 330 coupled to heating surface 310. Spacer 330 may elevate heating surface 310 above second end 140 of first conduit 110. Elevating heating surface 310 may allow heated fluids to exit between the heated surface and the second end of the first conduit. In some embodiments, heating surface 310 may be elevated about 0.125 to 1.0 inches, about 0.25 to 0.75 inches, or about 0.5 inches above second end 140 of first conduit 110. In some embodiments, a heating surface may be elevated about 0.5 inches.

In some embodiments, heating surface 310 may include lip 340 coupled to at least a portion of a perimeter of the heating surface. Lip 340 may inhibit escape of heated fluids from first conduit 110 such that the lip is heated by the heated fluids before the heated fluids escape. Heated fluids may include gases produced by burning the fuel positioned in first conduit 110. Heated fluids may include ambient air within first conduit 110 heated by the fire therein.

In some embodiments, stove system 100 may include deflector 350. Deflector 350 may be coupled to an interior surface of first side 170 of first conduit 110 substantially adjacent second end 140 of the first conduit. Deflector 350 may assist in inhibiting flames from reaching second end 140 of first conduit 110.

Portions or all of a stove system may be formed from substantially fire and/or heat resistant materials. Appropriate materials may include ceramics, metals, and/or certain types of glass. In some embodiments, metals may include stainless steel, aluminum, and/or cast iron. In some embodiments, at least a portion or all of a stove system may be formed from heavy gauge cast iron. In some embodiments, at least a portion or all of a stove system may be formed from mild carbon steel.

In some embodiments, a method of heating materials using stove system 100 may include inserting fuel through third conduit 260 positioned substantially above fourth conduit 270. The third and fourth conduit may form second conduit 180. The second conduit may be coupled to second side 190 of first conduit 110 substantially adjacent first end 130 of the first conduit. The second side of the first conduit may be substantially opposite first side 170 of first conduit 110. Second conduit 180 may be substantially orthogonal to first conduit 110.

In some embodiments, the method may include positioning fuel in first end 130 of the first conduit 110.

In some embodiments, the method may include allowing air to flow through fourth conduit 270 and a second opening 150 positioned in first side 170 of first conduit 110 substantially adjacent first end 130 of the first conduit.

In some embodiments, the method may include inhibiting flames from reaching second end 140 of first conduit 110 using deflector 350. Deflector 350 may be coupled to an interior surface of first side 170 of first conduit 110 substantially adjacent second end 140 of the first conduit.

In some embodiments, the method may include heating surface 310 coupled to second end 140 of first conduit 110. The heating surface may include plurality of openings 320. Plurality of openings 320 may function such that heat produced in the first conduit is transferred to a material positioned on and/or above the heating surface.

In some embodiments, the method may include elevating heating surface 310 above second end 140 of first conduit 110 using spacer 330. Spacer 330 may be coupled to heating surface 310 such that the heating surface is elevated above second end 140 of first conduit 110.

In some embodiments, the method may include allowing heated fluids to exit between heated surface 310 and second end 140 of first conduit 110.

In some embodiments, the method may include inhibiting escape of heated fluids from first conduit 110 such that lip 340 is heated by the heated fluids. The lip may be coupled to at least a portion of a perimeter of heating surface 310.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A stove system, comprising:
a first conduit comprising:
a first diameter;
a first end, wherein the first end inhibits fuel positioned in the first conduit from exiting the first conduit;
a second end, wherein the second end of the first conduit comprises a first opening; and
a second opening positioned in a first side of the first conduit substantially adjacent the first end of the first conduit;
a second conduit coupled to a second side of the first conduit substantially proximate the first end of the first conduit, wherein the second side of the first conduit is substantially opposite the first side of the first conduit, and wherein the second conduit comprises:
a second diameter, wherein the second diameter is smaller than the first diameter of the first conduit;
a divider positioned at least within the second conduit which divides the second conduit into a third and a fourth conduit, wherein the third conduit is positioned substantially above the fourth conduit, wherein the third conduit allows at least fuel to be positioned in the first conduit, and wherein the fourth conduit allows air to enter the first conduit;
a third end comprising a third opening which couples the interior of the first conduit to the interior of the second conduit; and
a fourth end comprising a fourth opening which allows communication with the third opening through the second conduit; and
at least one elongated member coupled to an exterior surface of the first end of the first conduit, wherein the at least one elongated member raises, during use, the first conduit above a surface upon which the stove is positioned.

2. The device of claim 1, wherein the fuel comprises wood.

3. The device of claim 1, wherein the second conduit is substantially orthogonal to the first conduit,

4. The device of claim 1, wherein the divider extends beyond the fourth opening of the second conduit.

5. The device of claim 1, wherein a distance between an upper exterior surface of the second conduit and the second end of the first conduit is about 4 inches to about 6 inches or about 4.5 inches to about 5.5 inches.

6. The device of claim 1, wherein the first conduit comprises a substantially square cross section with an approximately 5 inch width, and wherein the second conduit comprises a substantially square cross section with an approximately 4 inch width.

7. The device of claim 1, further comprising a lip coupled to the exterior surface of the first conduit below the second opening.

8. The device of claim 1, further comprising a lip coupled to the exterior surface of the first conduit below the second opening, wherein the lip is angled towards the second end of the first conduit.

9. The device of claim 1, further comprising a lip coupled to the exterior surface of the first conduit below the second opening, wherein the lip is angled towards the second end of the first conduit such that solid materials are inhibited from exiting the first conduit through the second opening.

10. The device of claim 1, wherein the second opening and the fourth conduit allow air to flow through the first conduit.

11. The device of claim 1, further comprising a deflector coupled to an interior surface of the first side of the first conduit substantially adjacent the second end of the first conduit.

12. The device of claim 1, further comprising a deflector coupled to an interior surface of the first side of the first conduit substantially adjacent the second end of the first conduit, wherein the deflector assists in inhibiting flames from reaching the second end of the first conduit.

13. The device of claim 1, further comprising a heating surface coupled to the second end of the first conduit.

14. The device of claim 1, further comprising a heating surface coupled to the second end of the first conduit using a hinge.

15. The device of claim 1, further comprising a heating surface coupled to the second end of the first conduit, wherein the heating surface comprises a plurality of openings.

16. The device of claim 1, further comprising a heating surface coupled to the second end of the first conduit, wherein the heating surface comprises a plurality of openings such that heat produced in the first conduit is transferred to a material positioned on and/or above the heating surface.

17. The device of claim 16, further comprising a spacer coupled to the heating surface such that the heating surface is elevated above the second end of the first conduit.

18. The device of claim 16, further comprising a spacer coupled to the heating surface such that the heating surface is elevated about 0.5 inches above the second end of the first conduit allowing heated fluids to exit between the heated surface and the second end of the first conduit.

19. The device of claim 16, wherein the heating surface comprises a lip coupled to at least a portion of a perimeter of the heating surface.

20. The device of claim 16, wherein the heating surface comprises a lip coupled to at least a portion of a perimeter of the heating surface, wherein the lip inhibits escape of heated fluids from the first conduit such that the lip is heated by the heated fluids.

21. The device of claim 1, wherein the second opening is about half as tall as the fourth conduit.

22. The device of claim 1, wherein the fourth conduit is about one third as tall as the third conduit.

23. The device of claim 1, wherein a height of a top of the second opening is positioned below a height of a bottom of the third opening.

24. A method of heating materials using a stove, comprising:
inserting fuel through a third conduit positioned substantially above a fourth conduit, wherein the third and fourth conduit form a second conduit, wherein the second conduit is coupled to a second side of a first conduit substantially adjacent a first end of the first conduit, wherein the second side of the first conduit is substantially opposite a first side of the first conduit, wherein the second conduit is substantially orthogonal to the first conduit;
positioning fuel in the first end of the first conduit;
allowing air to flow through the fourth conduit and a second opening positioned in the first side of the first conduit substantially adjacent the first end of the first conduit;
inhibiting flames from reaching the second end of the first conduit using a deflector coupled to an interior surface of the first side of the first conduit substantially adjacent the second end of the first conduit;
heating a heating surface coupled to the second end of the first conduit, wherein the heating surface comprises a plurality of openings such that heat produced in the first conduit is transferred to a material positioned on and/or above the heating surface.

25. The method of claim 24, further comprising:
elevating the heating surface above the second end of the first conduit using a spacer coupled to the heating surface such that the heating surface is elevated above the second end of the first conduit;
allowing heated fluids to exit between the heated surface and the second end of the first conduit; and
inhibiting escape of heated fluids from the first conduit such that a lip is heated by the heated fluids, wherein the lip coupled to at least a portion of a perimeter of the heating surface.

26. The method of claim 24, further comprising, positioning fuel in the first end of the first conduit using the third conduit.
